(19) United States
(12) Patent Application Publication
(10) Pub. No.: US 2026/0364708 A1
(43) Pub. Date: Nov. 19, 2026

(54) BURR REMOVAL APPARATUS AND BURR REMOVAL METHOD

(71) Applicant: DISCO CORPORATION, Tokyo (JP)

(72) Inventors: Takumi KOHEI, Tokyo (JP); Kohei YANAGIYA, Tokyo (JP)

(73) Assignee: DISCO CORPORATION, Tokyo (JP)

(21) Appl. No.: 19/208,787

(22) Filed: May 15, 2025

(51) Int. Cl. B23K 20/10; B23K 26/38

(52) U.S. Cl. CPC B23K 20/10; B23K 26/38

(57) ABSTRACT

A burr removing apparatus includes a table to hold a workpiece, an ultrasonic oscillator unit including a plate and two ultrasonic horns, a water layer forming device to form a water layer between an upper surface of the workpiece and a lower surface of the ultrasonic oscillator unit, a horizontal movement assembly, a controller to operate the horizontal movement assembly to move the ultrasonic oscillator unit and the table relative to each other, a high-frequency power source to supply high-frequency power to the ultrasonic horns, and a power control unit to change a phase of the high-frequency power from the high-frequency power source. The burr removing apparatus removes the burr from the workpiece by changing a phase of the high-frequency power to be supplied to one of the two ultrasonic horns with respect to a phase of the other of the ultrasonic horns continuously.

### FIELD

The present disclosure relates to a burr removing apparatus and a method for removing burrs.

### BACKGROUND

Processing a workpiece with a cutting blade or laser may result in burrs formed in kerfs (cutting traces). Such burrs may, for example, in a case where the workpiece is a semiconductor workpiece, cause connection failures when chips obtained by dividing the workpiece are mounted on a substrate, and the like. Therefore, it is desirable to remove the burrs in advance.

A technique related to removal of burrs is disclosed in, for example, Japanese Patent Application Laid-Open Publication No. 2021-027183. This publication discloses a technique in which burrs is removed from the workpiece by water jetted toward the burrs. According to the publication, burrs may be removed by jetting water from a nozzle toward the workpiece while moving a tip of the nozzle to reciprocate along an arc-shaped path above a spinner table that rotates while holding the workpiece.

### SUMMARY

However, the technique disclosed in the above publication may have a margin for improvement in terms of reducing time required to remove burrs from kerfs. Further, there may also be a margin for improvement in terms of reliable removal of burrs from kerfs. In view of such issues, the present disclosure aims to provide a burr removing apparatus and a method for removing burrs formed in a plate-formed workpiece such as a semiconductor workpiece.

According to an aspect of the present disclosure, a burr removing apparatus configured to remove a burr formed in a kerf, which is formed in a workpiece with a cutting blade or a laser beam, includes a table configured to hold a lower surface of the workpiece; an ultrasonic oscillator unit arranged so as to be spaced apart from an upper surface of the workpiece held by the table, the ultrasonic oscillator unit being configured to emit ultrasonic vibration toward the upper surface of the workpiece; and a water layer forming device configured to form a water layer between the upper surface of the workpiece held by the table and the lower surface of the ultrasonic oscillator unit. The ultrasonic oscillator unit includes a plate and two columnar ultrasonic horns spaced apart from each other. The burr removing apparatus further includes a horizontal movement assembly configured to move the ultrasonic oscillator unit and the table relative to each other in parallel with the upper surface of the table, a controller configured to operate the horizontal movement assembly to move the ultrasonic oscillator unit and the table relative to each other, a high-frequency power source configured to supply high-frequency power to the two ultrasonic horns, and a power control unit configured to change a phase of the high-frequency power to be supplied to one of the ultrasonic horns with respect to a phase of the other of the ultrasonic horns continuously. The burr removing apparatus is configured to remove the burr from the workpiece by changing the phase of the high-frequency power to be supplied to the one of the two ultrasonic horns continuously and causing a location, where the ultrasonic vibrations emitted from the two ultrasonic horns are amplified, to be moved on the upper surface of the workpiece.

According to the burr removing apparatus configured as above, burrs formed in the workpiece may be removed.

### BRIEF DESCRIPTION OF THE DRAWINGS

FIG. 1 is a perspective view of a frame set including a workpiece according to an embodiment.

FIG. 2 is a cross-sectional view of a cutting apparatus according to the embodiment.

FIG. 3 is a cross-sectional view of a burr removing apparatus according to a first embodiment.

FIG. 4 is a diagram illustrating an ultrasonic horn included in an ultrasonic oscillator unit according to the first embodiment.

FIG. 5 illustrates wavefronts of in-phase ultrasonic waves output from a pair of ultrasonic horns and points where constructive and destructive interferences between the in-phase ultrasonic vibrations occur, according to the first embodiment.

FIG. 6 shows waveforms of ultrasonic vibrations output from the pair of ultrasonic horns according to the first embodiment.

FIG. 7A is a first diagram illustrating positional changes of the constructive and destructive interferences points between the ultrasonic vibrations output from the pair of ultrasonic horns in accordance with a phase difference between the ultrasonic vibrations according to the first embodiment.

FIG. 7B is a second diagram illustrating positional changes of the constructive and destructive interferences points between the ultrasonic vibrations output from the pair of ultrasonic horns in accordance with a phase difference between the ultrasonic vibrations according to the first embodiment.

FIG. 8A is a third diagram illustrating positional changes of the constructive and destructive interferences points between the ultrasonic vibrations output from the pair of ultrasonic horns in accordance with a phase difference between the ultrasonic vibrations according to the first embodiment.

FIG. 8B is a fourth diagram illustrating positional changes of the constructive and destructive interferences points between the ultrasonic vibrations output from the pair of ultrasonic horns in accordance with a phase difference between the ultrasonic vibrations according to the first embodiment.

FIG. 9 is a cross-sectional partial view of a burr removing apparatus according to a second embodiment.

FIG. 10 illustrates wavefronts of in-phase ultrasonic waves output from a pair of ultrasonic horns arranged along a predetermined dicing line and points where constructive and destructive interferences between the in-phase ultrasonic vibrations occur.

FIG. 11 is a cross-sectional view of a laser processing apparatus according to another embodiment.

### DESCRIPTION OF EMBODIMENTS

Hereinbelow, a technique for removing burrs formed on a workpiece processed with a cutting blade or laser beam will be described. Although the following description uses a semiconductor device manufacturing process as an example, application of the burr removing apparatus described below is not limited to the semiconductor device manufacturing processes.

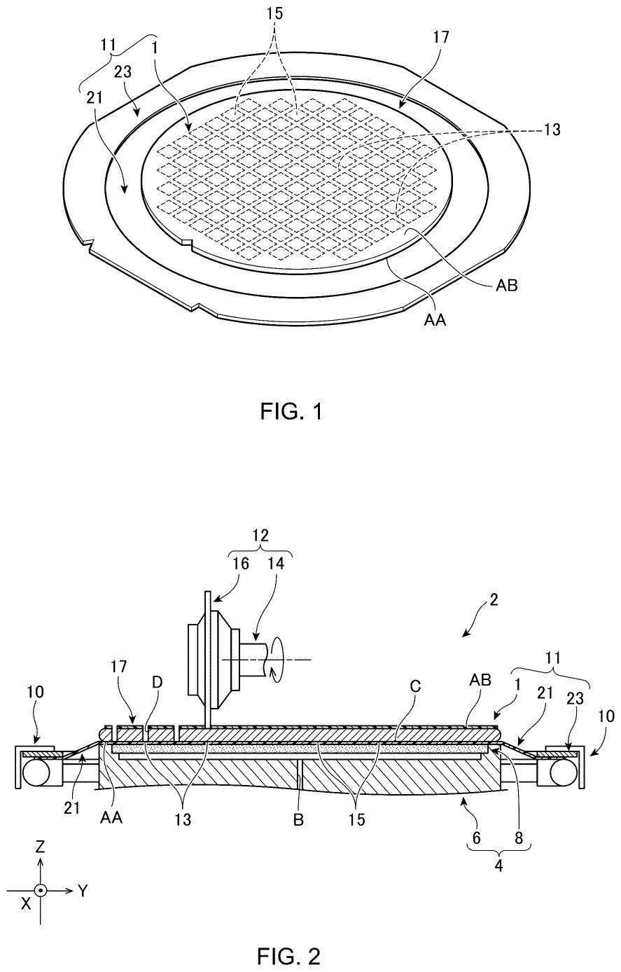

FIG. 1 is a perspective view of a frame set 11 including a workpiece 1 according to an embodiment. The frame set 11 shown in FIG. 1 is composed integrally of a ring-shaped frame 23 and the workpiece 1 adhered to a tape 21 that closes an opening of the frame 23. In the frame set 11, the workpiece 1 is supported by the frame 23 via the tape 21.

The workpiece 1 according to the present embodiment includes, for example, a disk-shaped workpiece formed of a semiconductor material such as silicon (Si), i.e., a wafer. However, the material of the workpiece 1 is not necessarily limited. The workpiece 1 may be a semiconductor substrate other than silicon, such as gallium arsenide, or an inorganic material substrate, such as ceramic, glass, or sapphire. Furthermore, the shape of the workpiece 1 is not limited to a disk but may be of any shape, such as a plate-shaped substrate other than a circular shape.

The workpiece 1 has a front surface AA and a back surface AB. On the front surface AA of the workpiece 1, a plurality of small regions partitioned by a plurality of predetermined dicing lines 13 (also referred to as streets) are provided. In each of the small regions, a device 15 such as an integrated circuit is formed. The tape 21 that closes the opening of the frame 23 is adhered to the front surface AA of the workpiece 1.

A film 17 is provided on the back surface AB, which is opposite to the front surface AA. The film 17 is formed not only in an area on the back surface AB corresponding to the devices 15 but also in areas corresponding to the predetermined dicing lines 13. The film 17 may be, for example, made of a metal such as gold, silver, titanium, or nickel, and may be formed in a method such as sputtering, vapor deposition, or chemical vapor deposition (CVD).

FIG. 2 is a cross-sectional view of a cutting apparatus 2 according to the present embodiment. With reference to FIG. 2, an example of a process to the workpiece 1, in which regions corresponding to the predetermined dicing lines 13 in the workpiece 1 are cut from the side of the film 17 formed on the back surface AB, will be described below.

The cutting apparatus 2 shown in FIG. 2 includes a chuck table 4 to hold the workpiece 1 included in the frame set 11, a plurality of clamps 10 to hold the frame 23 included in the frame set 11, and a cutting unit 12 to cut the workpiece 1 included in the frame set 11 held by the chuck table 4 and the clamps 10.

The chuck table 4 includes a frame 6 having a recess formed on an upper surface thereof, and a holder plate 8 embedded in the recess of the frame 6. In the frame 6, a flow path B that connects the recess in the frame 6 and a suction source (not shown) is formed. The holder plate 8 is a porous plate. The plurality of clamps 10 are provided around the frame 6.

The cutting unit 12 is provided above the chuck table 4. The cutting unit 12 includes a spindle 14, of which rotation axis is substantially parallel to a holder surface C being a surface of the holder plate 8, and a cutting blade 16 mounted to the spindle 14. The spindle 14 is connected to a rotation driving source, which is not shown. The cutting blade 16 is rotatable by a driving force from the rotation driving source connected to the spindle 14.

Furthermore, the chuck table 4 is supported by a movement assembly (not shown), which is movable in a direction substantially parallel to the holder surface C (Y-axis direction), and a rotation assembly (not shown), which is rotatable about an axis intersecting substantially orthogonally with the holder surface C. Moreover, the cutting unit 12 is provided with a movement assembly, which is movable in a direction substantially parallel to the holder surface C (X-axis direction intersecting orthogonally with the Y-axis direction) and in a direction intersecting substantially orthogonally with the holder surface C (Z-axis direction).

For cutting the workpiece 1 into the regions corresponding to the predetermined dicing lines 13, from the side of the film 17, first, the cutting apparatus 2 configured as described above holds the frame set 11 with the front surface AA of the workpiece 1 facing the chuck table 4. In particular, the plurality of clamps 10 hold the frame 23. Further, a suction source (not shown) generates a negative pressure on the holder surface C being the surface of the holder plate 8, and with the suctioning effect, the chuck table 4 holds the workpiece 1 via the tape 21 with the negative pressure.

Next, the cutting apparatus 2 locates the cutting blade 16 in one of the regions corresponding to the predetermined dicing lines 13. For example, the rotation assembly that supports the chuck table 4 may rotate the chuck table 4 so that the predetermined dicing line 13 aligns parallel to the cutting blade 16. Further, the chuck table 4 and the cutting unit 12 are moved such that the cutting blade 16 is located above the region corresponding to the predetermined dicing line 13 by a movement assembly, which supports the chuck table 4 and moves the chuck table 4 in a cut-feeding direction for the cutting blade 16, and a movement assembly, which supports the cutting unit 12 and moves the cutting unit 12 in the direction of the rotational axis of the spindle 14.

When the cutting blade 16 is located above the region corresponding to the predetermined dicing line 13 by the movement assembly supporting the cutting unit 12, the motor rotates the spindle 14 and the cutting blade 16, and the cutting unit 12 is lowered to cut the region corresponding to the predetermined dicing line 13 from the film 17 side with the cutting blade 16. Accordingly, a groove D is formed at the position corresponding to the predetermined dicing line 13, dividing the area adjacent to the region corresponding to the predetermined dicing line 13 into the small regions where the devices 15 are formed. The groove D is an example of the kerf formed in the workpiece 1. The above operation is repeated for all of the regions corresponding to the predetermined dicing lines 13.

Optionally, the tape 21 to close the opening of the frame 23 may be adhered to the back surface AB of the workpiece 1, and the cutting blade 16 may cut into the workpiece 1 from the front surface AA side to form the groove D.

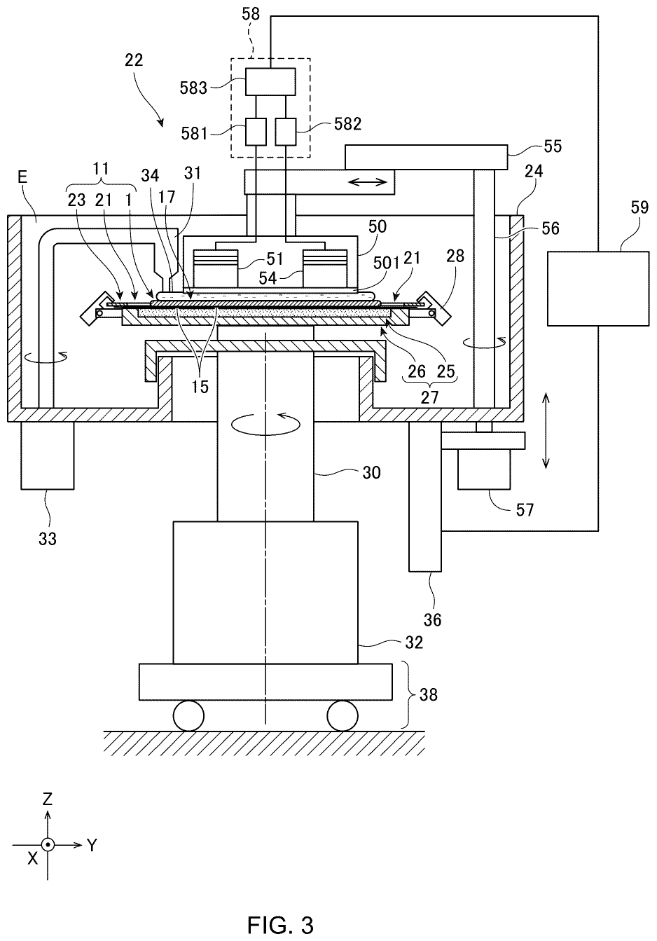

In such a cutting process using the cutting blade 16, cutting the film 17 and the workpiece 1 may generate burrs at upper edges of the groove D. As described above, burrs formed in the cutting process may cause connection failures and may lower the quality of the devices. Therefore, in the present embodiment, the burrs generated in the workpiece 1, where the groove D are formed, are removed by a burr removing apparatus 22 shown in FIG. 3.

### First Embodiment

FIG. 3 is a cross-sectional view of a burr removing apparatus 22 according to the first embodiment. The burr removing apparatus 22 shown in FIG. 3 is an apparatus that may remove burrs formed in the grooves D that are formed in the workpiece 1 with the cutting blade 16. The burr removing apparatus 22 includes a table 27 to hold a lower surface of the workpiece 1, an ultrasonic oscillator unit 50 to emit ultrasonic vibration at the upper surface of the workpiece 1, and a water layer forming device 31. When the workpiece 1 is cut from the side of the film 17 formed on the back surface AB with the cutting blade 16, and where burrs are formed on the back surface AB side of the grooves D, for removing the burrs in a process with the burr removing apparatus 22, the workpiece 1 is set in an orientation such that the front surface AA of the workpiece 1 faces downward and the back surface AB faces upward.

The ultrasonic oscillator unit 50 is arranged so as to be spaced apart from the upper surface of the workpiece 1 held by the table 27. The water layer forming device 31 may form a water layer 34 in a gap between the upper surface of the workpiece 1 held on the table 27 and the lower surface of the ultrasonic oscillator unit 50. A distance from the lower surface of the ultrasonic oscillator unit 50 (a lower surface of the plate 501 which will be described later) to the upper surface of the workpiece 1 may be, for example, 5 mm, and the water layer 34 is formed in the gap. In other words, the gap is filled with the water layer 34.

The table 27 is, together with clamps 28, provided in a space E inside a cylindrical housing 24 that houses the workpiece 1. The clamps 28 may hold the frame 23, which supports the workpiece 1 via the tape 21.

The table 27 is a chuck table including a frame 26 having a recess formed therein and a holder plate 25 embedded in the recess, and holds the lower surface of the workpiece 1. By a suction act of a suction source, which is not shown but is connected to the recess of the frame 26 via a flow path, the table 27 may suction the lower surface of the workpiece 1 and hold the workpiece 1 against the surface (holder surface) of the holder plate 25. The holder plate 25 is a porous plate. The clamps 28 are provided around the frame 26 of the table 27.

With the front surface AA of the workpiece 1 (the surface on which the devices 15 are formed) facing the table 27, the workpiece 1 is suctioned and held against the table 27, and the frame 23 is clamped by the clamps 28. Thus, the burr removing apparatus 22 holds the frame set 11.

Further, the table 27 is fixed to a spindle 30 that may be rotated by a table rotating motor 32. As the table 27 rotates by the rotation of the table rotating motor 32, an orientation of the workpiece 1 held on the table 27 changes.

In the burr removing apparatus 22 configured as described above, the ultrasonic oscillator unit 50 applies ultrasonic vibration to the water layer 34 formed by the water layer forming device 31 in a procedure described below. As a result, the burr removing apparatus 22 may remove burrs formed on the workpiece 1 using the ultrasonic vibration transmitted through the water layer 34.

First, a holding step to hold the table 27 on the workpiece 1 is performed. Once the workpiece 1 is held on the table 27, a controller 59 controls rotation of the table rotating motor 32 such that the predetermined dicing lines 13 formed in a grid pattern on the workpiece 1 are aligned parallel to the X-axis direction and Y-axis direction. In other words, the grooves D (kerfs) are formed along the X-axis direction and Y-axis direction, and the X-axis direction and Y-axis direction are extending directions of the grooves D (kerfs).

Next, a water layer forming step is performed. In the water layer forming step, the controller 59 controls a swivel motor 33 to move the water layer forming device 31 above the upper surface of the workpiece 1 by rotating the swivel motor 33. The water layer forming device 31 includes a nozzle that guides water onto the workpiece 1. The burr removing apparatus 22, under the control of the controller 59, discharges water from a water supply source, which is not shown, onto the workpiece 1 through the water layer forming device 31. The water discharged onto the workpiece 1 from the nozzle (water layer forming device 31) forms the water layer 34 on the workpiece 1 by surface tension.

The burr removing apparatus 22 may form the water layer 34 such that the entire upper surface of the workpiece 1 is covered with the water layer 34, or such that at least a part of the upper surface of the workpiece 1, specifically the regions including the predetermined dicing lines 13 that are to be scanned by ultrasonic vibrations, is covered with the water layer 34.

When the water layer 34 is formed, the controller 59 controls the swivel motor 33 to retract the water layer forming device 31 from the position above the workpiece 1 by rotating the swivel motor 33. Further, the controller 59 controls a swivel motor 57 to rotate a spindle 56, thereby moving the ultrasonic oscillator unit 50 to a position above the workpiece 1.

Furthermore, the controller 59 controls a horizontal movement assembly 55 to locate the ultrasonic oscillator unit 50 substantially at a center of the workpiece 1, and controls a lift/lower device 36 to lower the ultrasonic oscillator unit 50 until the lower surface of the ultrasonic oscillator unit 50 contacts the water layer 34. Accordingly, the gap between the upper surface of the workpiece 1 and the lower surface of the ultrasonic oscillator unit 50 is filled with the water layer 34. In other words, the water layer 34 is formed between the upper surface of the workpiece 1 and the lower surface of the ultrasonic oscillator unit 50.

Next, a burr removing step is performed. Once the ultrasonic oscillator unit 50 is located at a correct position with respect to the table 27, the controller 59 controls a power source unit 58. Accordingly, the ultrasonic oscillator unit 50 applies ultrasonic vibration to the water layer 34 formed by the water layer forming device 31, and the ultrasonic vibration is transmitted through the water layer 34 to the burrs on the workpiece 1 held by the table 27 to act on the burrs.

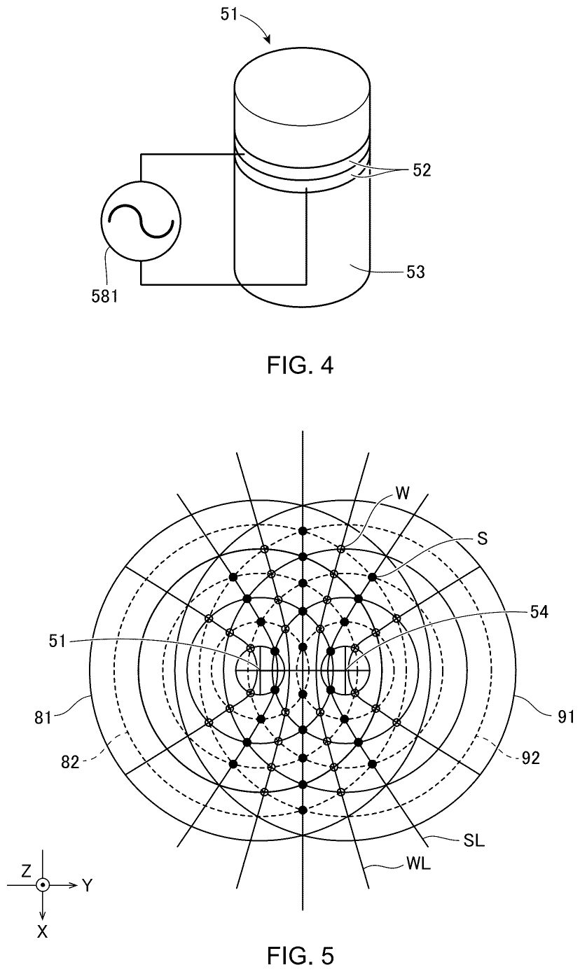

FIG. 4 is a diagram illustrating one of ultrasonic horns included in the ultrasonic oscillator unit 50 according to the present embodiment. FIG. 5 illustrates wavefronts of in-phase ultrasonic waves output from a pair of ultrasonic horns and points where constructive and destructive interferences between the in-phase ultrasonic vibrations occur, according to the first embodiment. The above-described burr removing apparatus 22 is configured to remove burrs formed on the workpiece 1 with ultrasonic vibrations amplified by utilizing the interference of ultrasonic vibrations applied to the water layer 34. Below, with reference to FIGS. 3 to 5, the configuration of the burr removing apparatus 22 for removing burrs formed on the workpiece 1 using the amplified ultrasonic vibration will be described.

As shown in FIG. 3, the burr removing apparatus 22 includes a horizontal movement assembly (horizontal movement assembly 38 and horizontal movement assembly 55) to move the ultrasonic oscillator unit 50 and the table 27 relative to each other in a direction parallel to the upper surface of the table 27, a power source unit 58 to control the ultrasonic oscillator unit 50, and the controller 59 to control the movement assemblies and the power source unit 58.

The horizontal movement assembly includes a horizontal movement assembly 55, which is a Y-axis movement assembly for moving the ultrasonic oscillator unit 50 and the table 27 relative to each other in the Y-axis direction, and a horizontal movement assembly 38, which is an X-axis movement assembly for moving the ultrasonic oscillator unit 50 and the table 27 relative to each other in the X-axis direction intersecting orthogonally with the Y-axis direction. The horizontal movement assembly 55 may be, for example, a slider to move an arm supporting the ultrasonic oscillator unit 50 slidably in the Y-axis direction, and is configured to move the ultrasonic oscillator unit 50 in the Y-axis direction, thereby moving the ultrasonic oscillator unit 50 relative to the table 27 in the Y-axis direction. The horizontal movement assembly 38 may be, for example, a table on which a spindle 30 and a table rotating motor 32 are mounted, and is configured to move the table 27 relative to the ultrasonic oscillator unit 50 in the X-axis direction by moving the spindle 30 and the table rotating motor 32 in the X-axis direction.

The spindle 30 and the table rotating motor 32 mounted on the horizontal movement assembly 38 are an example of the rotation assembly for rotating the table 27 relative to the ultrasonic oscillator unit 50. In the burr removing apparatus 22, with the horizontal movement assembly and the rotation assembly, the position and orientation of the table 27 relative to the ultrasonic oscillator unit 50 may be adjusted as desired, and thereby the position and orientation of the workpiece 1 with respect to the ultrasonic oscillator unit 50 may be adjusted.

The power source unit 58 includes two high-frequency power source 581 and a high-frequency power source 582, which may supply high-frequency power individually to the two ultrasonic horns in the ultrasonic oscillator unit 50, and a power control unit 583, which may control power supply to the high-frequency power source 581 and the high-frequency power source 582. The controller 59 may include, for example, a processor for executing various processes and a storage (memory) for storing various parameters and programs. The storage in the controller 59 stores a program for executing the burr removal process using the ultrasonic oscillator unit 50 as a part of the control program of the burr removing apparatus 22. Specifically, by executing the program, the controller 59 may cause the ultrasonic oscillator unit 50 and the table 27 to move relative to each other via the horizontal movement assembly, and may supply power to the ultrasonic oscillator unit 50 via the power source unit 58. Accordingly, the burr removing apparatus 22 may remove burrs through the burr removing process with amplified ultrasonic vibration.

The ultrasonic oscillator unit 50 includes a plate 501 and two cylindrical ultrasonic horns 51, 54 arranged so as to be spaced apart from each other on the plate 501. A diameter of each ultrasonic horn 51, 54 may be, for example, 40 mm, and a distance between a center of the ultrasonic horn 51 and a center of the ultrasonic horn 54 may be, for example, 100 mm. A diameter of the wafer, i.e., the workpiece 1, may be, for example, 200 mm.

The plate 501 supporting the ultrasonic horn 51 and the ultrasonic horn 54 is a metal plate made of, for example, titanium, stainless steel, or aluminum. By providing two ultrasonic horns 51, 54 on the plate 501, longitudinal waves oscillated from the lower surfaces of the ultrasonic horn 51 and the ultrasonic horn 54 are converted into transverse waves by the plate 501 and resonated. The ultrasonic horns 51, 54 are arranged on the plate 501 so as to be aligned in a direction parallel to the upper surface of the table 27.

In the present embodiment, a distance between the centers of the ultrasonic horn 51 and the ultrasonic horn 54 is a half of the diameter of the wafer, and the plate 501 that supports the ultrasonic horn 51 and the ultrasonic horn 54 has a diameter of 140 mm or more. Therefore, by locating the ultrasonic oscillator unit 50 at the center of the workpiece 1 using the horizontal movement assembly, most of the diameter of the workpiece 1 being 200 mm is covered by the plate 501. Ultrasonic vibration generated through the plate 501 is transmitted to a region expanded beyond the region covered by the plate 501. Therefore, in the present embodiment, simply by locating the ultrasonic oscillator unit 50 at the center of the workpiece 1, the ultrasonic vibration may act on substantially the entire surface of the workpiece 1.

As shown in FIG. 4, the ultrasonic horn 51 includes a vibrator 52 that generates ultrasonic vibration, and a horn portion 53 that emits the ultrasonic vibration generated by the vibrator 52. The vibrator 52 may be, for example, a bolt-clamped Langevin-type transducer (BLT) including a piezoelectric element. To the vibrator 52 of the ultrasonic horn 51, high-frequency power is supplied from the high-frequency power source 581. The ultrasonic horn 54 has the same structure as the ultrasonic horn 51, except that the vibrator 52 of the ultrasonic horn 54 is supplied with high-frequency power from the high-frequency power source 582 (see FIG. 3).

In the burr removing apparatus 22 configured as above, the controller 59 may remove burrs by executing a program and using amplified ultrasonic vibration. The following will describe, first, how the amplified ultrasonic vibration acts on burrs, and second, how phases are performed to efficiently and reliably remove the burrs from the workpiece 1 using the amplified ultrasonic vibration.

First, for causing the amplified ultrasonic vibration to act on burrs, the power source unit 58 supplies high-frequency power to the pair of ultrasonic horns 51, 54 in the ultrasonic oscillator unit 50. Specifically, under the control of the power control unit 583, the high-frequency power source 581 supplies high-frequency power to the ultrasonic horn 51, and the high-frequency power source 582 supplies high-frequency power to the ultrasonic horn 54.

Accordingly, the vibrators 52 (piezoelectric elements) included in the ultrasonic horns 51, 54 deform, and ultrasonic vibration is emitted from the ultrasonic horns 51, 54. The ultrasonic vibration transmitted from each vibrator 52 to the horn portion 53 is emitted outward in a form of ripples from the lower surface of the ultrasonic oscillator unit 50. The ultrasonic vibrations emitted from the two ultrasonic horns 51, 54 to the outside of the ultrasonic oscillator unit 50 interfere with each other. As a result, in some positions, the ultrasonic vibrations are amplified (constructive interference points), and in another positions, the ultrasonic vibrations are attenuated (destructive interference points).

For example, in a case where the high-frequency power source 581 and the high-frequency power source 582 supply high-frequency power of the same frequency and the same phase to the ultrasonic horn 51 and the ultrasonic horn 54, respectively, the ultrasonic horn 51 and the ultrasonic horn 54 may be regarded as two wave sources that generate ultrasonic vibrations of the same frequency and the same phase. In this case, the positions where the ultrasonic vibrations are amplified and the positions where the ultrasonic vibrations are attenuated are in a pattern as shown in FIG. 5.

In FIG. 5, each circle 81 drawn in a solid line among a plurality of concentric circles centered on the ultrasonic horn 51 represents a wavefront of the ultrasonic vibration emitted from the ultrasonic horn 51 at the maximum amplitude in a positive (+) direction. Each circle 82 drawn in a dashed line among the concentric circles centered on the ultrasonic horn 51 represents a wavefront of the ultrasonic vibration emitted from the ultrasonic horn 51 at the maximum amplitude in a negative (−) direction. Each circle 91drawn in a solid line among a plurality of concentric circles centered on the ultrasonic horn 54 represents a wavefront of the ultrasonic vibration emitted from the ultrasonic horn 54 at the maximum amplitude in the (+) positive direction. Each circle 92drawn in a dashed line among the concentric circles centered on the ultrasonic horn 54 represents a wavefront of the ultrasonic vibration emitted from the ultrasonic horn 54 at the maximum amplitude in the negative (−) direction.

Each line SL connects positions where the ultrasonic vibrations constructively interfere, and each line WL connects positions where the ultrasonic vibrations destructively interfere. Each black dot S on the line SL indicates a point where the circle 81 and the circle 91 overlap or the circle 82 and the circle 92 overlap, representing a position where the ultrasonic vibrations interfere at the maximum amplitude and constructively reinforce each other. Each white dot W on the line SL indicates a point where the circle 81 and the circle 92 overlap or the circle 82 and the circle 91 overlap, representing a position where the ultrasonic vibrations interfere at the maximum amplitude and destructively cancel each other.

The constructively interfering position is a position where a difference between a distance from the ultrasonic horn 51 and a distance from the ultrasonic horn 54 is equal to an integer multiple of the wavelength of the ultrasonic wave (i.e., where the phase difference is an integer multiple of 2π). Therefore, as shown in FIG. 5, under a condition where the ultrasonic waves are spherical waves, the positions where the ultrasonic vibrations are amplified are distributed along an intermediate line (perpendicular bisector) between the ultrasonic horn 51 and the ultrasonic horn 54 and on hyperbolas centered on the intermediate line. Note that the intermediate line corresponds to a position where the phase difference is 0 (i.e., 2π*0).

As such, in the burr removing apparatus 22, positions where ultrasonic vibrations are amplified by interference are generated at points centered about the intermediate line between the ultrasonic horn 51 and the ultrasonic horn 54, and stronger ultrasonic vibration than those from a single ultrasonic horn may be applied to the burrs formed at the constructively interfering positions. Accordingly, burrs may be removed efficiently in a short time.

Further, for controlling the phase to reliably remove burrs from the workpiece 1 using the amplified ultrasonic vibration, the power control unit 583 controls the phases of the high-frequency powers supplied to the ultrasonic horn 51 and the ultrasonic horn 54 from the high-frequency power source 581 and from the high-frequency power source 582, respectively. More specifically, when the high-frequency power source 581 and the high-frequency power source 582 supply high-frequency powers to the ultrasonic horn 51 and the ultrasonic horn 54, respectively, the power control unit 583 continuously adjusts the phase of the high-frequency power to be supplied from the high-frequency power source 582 to the ultrasonic horn 54 with respect to the phase of the high-frequency power to be supplied from the power source 581 to the ultrasonic horn 51.

As shown in FIG. 5, a distance between the lines SL connecting the constructive interference positions is, in an area between the ultrasonic horn 51 and the ultrasonic horn 54, approximately half the wavelength (λ/2) of the ultrasonic vibration, and this distance increases as the distance from the ultrasonic horn 51 and the ultrasonic horn 54 increases. In order to reliably remove burrs formed on the workpiece 1, it is desirable that the amplified ultrasonic vibration acts not only on the lines SL shown in FIG. 5 but also on the regions between those lines SL across the entire workpiece 1, and the burr removing apparatus 22 enables such amplified ultrasonic vibration to act on the entire workpiece 1 by controlling the phases of the high-frequency powers

FIG. 5 shows an example, in which no phase difference is caused between the ultrasonic vibrations generated from the ultrasonic horn 51 and the ultrasonic horn 54; however, if a phase difference is caused between the ultrasonic vibrations emitted from the ultrasonic horn 51 and the ultrasonic horn 54, the position on the workpiece 1 where the phase difference is an integer multiple of 21 changes accordingly, and the positions of constructive interference of the ultrasonic vibrations also change. Therefore, by changing the phase difference between the ultrasonic vibrations emitted from the ultrasonic horn 51 and the ultrasonic horn 54 continuously or stepwise, the positions of constructive (or destructive) interference may also be shifted gradually.

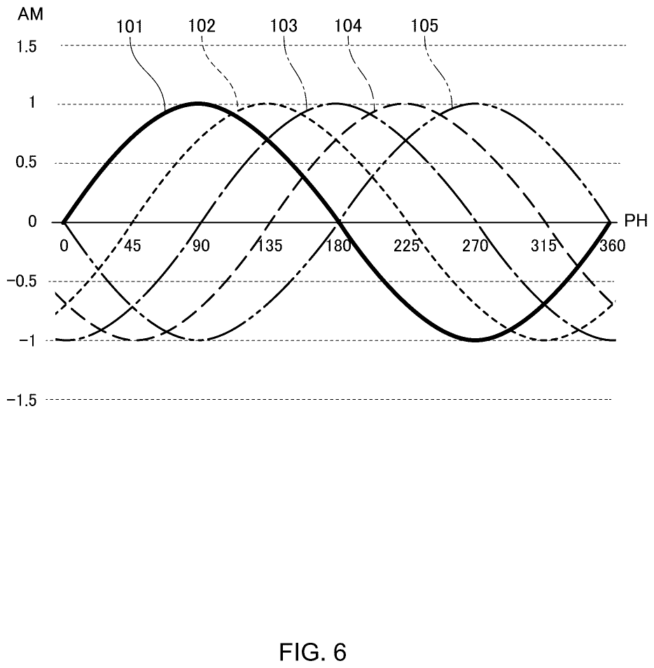

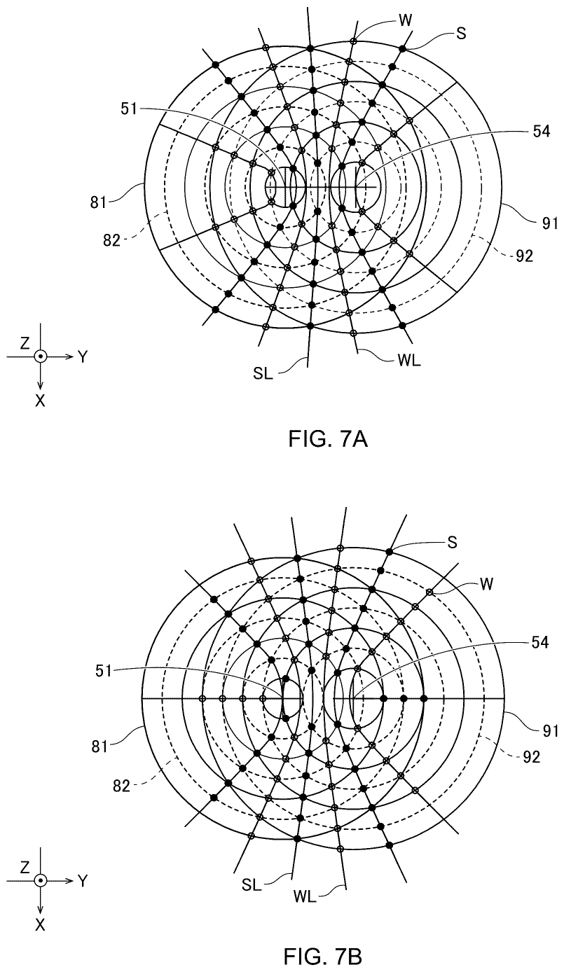

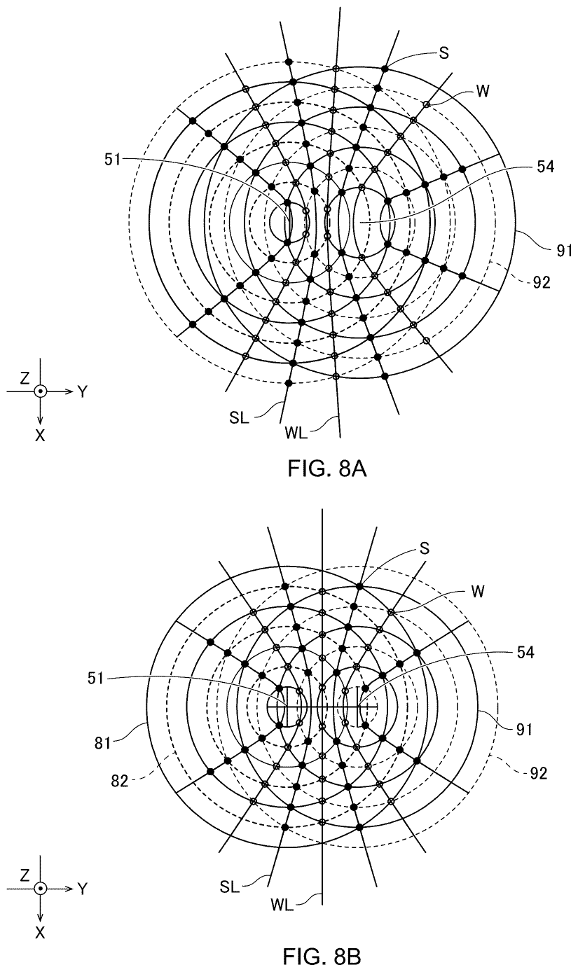

FIG. 6 illustrates waveforms of the ultrasonic vibrations output from the pair of ultrasonic horns 51, 54 according to the present embodiment. FIGS. 7A, 7B, 8A, and 8B are first through fourth diagrams illustrating how the positions of constructive interference and the positions of destructive interference of the ultrasonic vibrations change depending on the phase difference between the ultrasonic vibrations output from the pair of ultrasonic horns 51, 54 according to the present embodiment. Below, with reference to FIGS. 5 through 8B, how the constructive interference positions of the ultrasonic vibrations are moved by changing the phase of the ultrasonic vibrations emitted from the ultrasonic horn 54 will be described in detail.

FIG. 6 shows a waveform 101 of the ultrasonic vibration generated by the high-frequency power source 581, and waveforms 102, 103, 104, 105 of the ultrasonic vibrations generated by the high-frequency power source 582, of which phases are shifted by 45°, 90°, 135°, 180°, respectively, with respect to the ultrasonic vibration from the high-frequency power source 581.

FIG. 7A illustrates wavefronts of ultrasonic vibration when the ultrasonic vibration of waveform 101 is generated from the ultrasonic horn 51 and ultrasonic vibration of waveform 102 is generated from the ultrasonic horn 54. The ultrasonic vibration from the ultrasonic horn 54 is advanced in phase by 45° with respect to the ultrasonic vibration from the ultrasonic horn 51; therefore, the point, at which the phase difference between the two ultrasonic vibrations becomes zero, shifts toward the ultrasonic horn 51 with respect to the intermediate point (position equidistant) between the ultrasonic horn 51 and the ultrasonic horn 54, amplifying the ultrasonic vibration. Therefore, the lines SL connecting the points where the ultrasonic vibration is amplified are formed at positions slightly shifted toward the ultrasonic horn 51 with respect to the perpendicular bisector between the ultrasonic horn 51 and the ultrasonic horn 54 under the condition where the ultrasonic horn 51 and the ultrasonic horn 54 emit the ultrasonic vibrations in the same phase.

FIG. 7B illustrates wavefronts of ultrasonic vibration when the ultrasonic vibration of waveform 101 is generated from the ultrasonic horn 51 and ultrasonic vibration of waveform 103 is generated from the ultrasonic horn 54. FIG. 8A illustrates wavefronts of ultrasonic vibration when the ultrasonic vibration of waveform 101 is generated from the ultrasonic horn 51 and ultrasonic vibration of waveform 104 is generated from the ultrasonic horn 54. FIG. 8B illustrates wavefronts of ultrasonic vibration when the ultrasonic vibration of waveform 101 is generated from the ultrasonic horn 51 and ultrasonic vibration of waveform 105 is generated from the ultrasonic horn 54.

As shown in FIGS. 7A, 7B, 8A, and 8B, the lines SL connecting the points, at which the ultrasonic vibrations are amplified, are shifted toward the ultrasonic horn 51, and as the ultrasonic vibration emitted from the ultrasonic horn 54 advances further in phase with respect to the ultrasonic vibration emitted from the ultrasonic horn 51, the point at which the phase difference between the two ultrasonic vibrations becomes zero (0) shifts further toward the ultrasonic horn 51.

In FIG. 8B, where the phase difference reaches 180°, the ultrasonic vibrations from ultrasonic horn 51 and the ultrasonic horn 54 are in antiphase. Note that between FIG. 8B showing antiphase and FIG. 5 showing in-phase, the solid lines and the dashed lines of the wavefronts centered on the ultrasonic horn 54 are inverted, and the points where the ultrasonic vibrations are amplified and attenuated are also exactly opposite. In other words, a constructive interference point in FIG. 5 turns into a destructive interference point in FIG. 8B, and a destructive point in FIG. 5 turns into a constructive point in FIG. 8B. This shows that by gradually increasing the phase difference, the constructive lines SL on the intermediate line between the ultrasonic horn 51 and the ultrasonic horn 54 in FIG. 5 gradually moves toward the ultrasonic horn 51, and reaches the position of the adjacent destructive interference line WL, which was on the left of the intermediate line earlier in FIG. 5. Moreover, by changing the phase by another 180°, i.e., 360° in total, the constructive line SL that were originally on the intermediate line between the ultrasonic horn 51 and the ultrasonic horn 54 in FIG. 5 moves to the position of the adjacent constructive line SL, which was on the left of the intermediate line earlier in FIG. 5. In other words, each 360° phase shift moves the constructive lines SL to the respective next adjacent positions, allowing the amplified ultrasonic vibration to effectively act on the entire regions between adjacent lines SL shown in FIG. 5.

As described above, according to the burr removing apparatus 22, the controller 59 may control the power source unit 58 such that the power control unit 583 advances the phase of the high-frequency power to be supplied from the power source 582 with respect to the high-frequency power to be supplied from the power source 581, thereby, as shown in FIGS. 7A, 7B, 8A, and 8B, the phase of ultrasonic vibration from the ultrasonic horn 54 may advance relative to the phase of ultrasonic vibration from ultrasonic horn 51. As a result, the positions of the amplified ultrasonic vibration are shifted toward the ultrasonic horn 51.

Similarly, the controller 59 may control the power source unit 58 such that the power control unit 583 delays the phase of the high-frequency power to be supplied from the power source 582 with respect to the high-frequency power to be supplied from the power source 581, thereby, the phase of ultrasonic vibration from ultrasonic horn 54 may delay relative to the phase of ultrasonic vibration from ultrasonic horn 51. As a result, the positions of the amplified ultrasonic vibration are shifted toward the ultrasonic horn 54.

Thus, according to the burr removing apparatus 22, with the power control unit 583 controlling the phase difference of the high-frequency power to be supplied to the pair of ultrasonic horn 51 and the ultrasonic horn 54 from the two high-frequency power source 581 and high-frequency power source 582, the points where the ultrasonic vibration is amplified may be moved in the Y-axis direction between the ultrasonic horn 51 and the ultrasonic horn 54. In particular, by controlling the phase of the high-frequency powers and gradually changing the phase difference to 360° or more, the amplified ultrasonic vibration may be applied entirely across the entire workpiece 1 within the transmission range of the ultrasonic vibration. Accordingly, the amplified ultrasonic vibration acts on the burrs at any position on the workpiece 1, allowing reliable burr removal regardless of the location of the burrs.

As described above, according to the burr removing apparatus 22 of the present embodiment, burrs formed on the workpiece 1 may be efficiently removed using amplified ultrasonic vibration. Moreover, the amplified ultrasonic vibration may be applied to act over substantially the entire workpiece 1, without specifying the positions of the burrs (e.g., positions of the streets), burrs may be reliably removed from the entire workpiece 1 in a short time.

As described above, applying the ultrasonic vibration is effective for removing burrs, but effects achievable from the ultrasonic vibration may not be limited to burr removal. After removing burrs, the ultrasonic vibration may prevent the removed burrs from adhering once again to the workpiece 1. Further to removal of burrs, the ultrasonic vibration may exhibit a cleaning effect, by which dirt on the surface of the workpiece 1 may be detached and cleared from the surface of the workpiece 1. In particular, when the amplified ultrasonic vibration is applied while scanning across the entire workpiece 1, an even greater cleaning effect may be expected than applying constant vibration continuously.

In the present embodiment, an example where the ultrasonic horn 51 and the ultrasonic horn 54 are aligned in the Y-axis direction is explained; however, arrangement of the ultrasonic horn 51 and the ultrasonic horn 54 is not necessarily limited. For example, the ultrasonic horn 51 and the ultrasonic horn 54 may be aligned in the X-axis direction or may be aligned in a direction oblique to both the X-axis direction and the Y-axis direction.

In the present embodiment, an example where the table 27 is rotated by the table rotating motor 32 in advance so that the predetermined dicing lines 13 of the workpiece 1 are aligned with the X-axis and Y-axis directions is shown; however, the orientation of the predetermined dicing lines 13 may not necessarily be limited, but the predetermined dicing lines 13 may be oriented in a direction deviating from both the X-axis direction and the Y-axis direction.

In the present embodiment, an example where the ultrasonic horn 51 and the ultrasonic horn 54 are in the cylindrical shape is shown; however, the shape of the ultrasonic horn 51 and the ultrasonic horn 54 may not necessarily be limited to the cylindrical form as long as the ultrasonic horn 51 and the ultrasonic horn 54 are capable of generating ultrasonic vibration. For example, a columnar shape, in which the vibrator 52 and the horn portion 53 are aligned in a direction of height in the ultrasonic horn 51 and in the ultrasonic horn 54, may be preferable.

### Second Embodiment

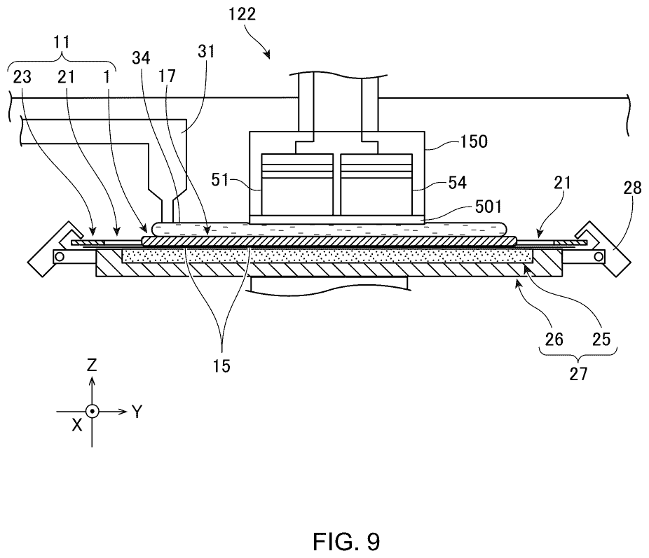

FIG. 9 is a cross-sectional partial view of a burr removing apparatus 122 according to a second embodiment. The configuration of the burr removing apparatus 122 of the present embodiment differs from the configuration of the burr removing apparatus 22 that the burr removing apparatus 122 has an ultrasonic oscillator unit 150 instead of the ultrasonic oscillator unit 50. The remainder of the configuration of the burr removing apparatus 122 is the same as that of the burr removing apparatus 22.

The ultrasonic oscillator unit 150, similarly to the ultrasonic oscillator unit 50, includes a plate 501 and a pair of ultrasonic horns (ultrasonic horn 51 and the ultrasonic horn 54). The ultrasonic oscillator unit 150 is configured to, also similarly to the ultrasonic oscillator unit 50, emit ultrasonic vibrations in which the phase difference between the pair of ultrasonic horns changes over time.

The ultrasonic oscillator unit 150 differs from the ultrasonic oscillator unit 50 in that the ultrasonic horn 51 and the ultrasonic horn 54 are arranged on the plate 501 such that the distance between the centers of the ultrasonic horn 51 and the ultrasonic horn 54 is 45 mm. In other words, in the present embodiment, the distance between the centers of the ultrasonic horn 51 and the ultrasonic horn 54 is approximately one-fifth of the diameter (200 mm) of the wafer, and a diameter of the plate 501 that supports the ultrasonic horn 51 and the ultrasonic horn 54 is at least 85 mm. Note that these values are less than a half of the diameter 200 mm of the workpiece 1.

In the burr removing apparatus 122 configured as above, by the controller 59 executing a program, burrs may be removed using amplified ultrasonic vibration as in the burr removing apparatus 22 of the first embodiment. However, for uniformly applying the amplified ultrasonic vibration to the entire workpiece 1, the burr removing apparatus 122 differs from the burr removing apparatus 22 in that the controller 59 operates the horizontal movement assembly (horizontal movement assembly 38 and the horizontal movement assembly 55 shown in FIG. 3) to continuously move the ultrasonic oscillator unit 150 and the table 27 relative to each other, so that burrs are removed from the entire upper surface of the workpiece 1.

The following describes how the amplified ultrasonic vibration is uniformly applied to the entire workpiece 1 using the horizontal movement assembly.

Similarly to the burr removing apparatus 22 described above, in the burr removing apparatus 122, the positions where ultrasonic vibrations are amplified by interference are distributed along the perpendicular bisector between the ultrasonic horn 51 and the ultrasonic horn 54 and hyperbolas centered on intermediate line. Moreover, by the power control unit 583 controlling the phase difference, the amplified ultrasonic vibration is generated to act also on the regions between the lines SL where constructive interference occurs in the same phase. However, a sound pressure (intensity) of the ultrasonic vibration is not uniform throughout the positions where the ultrasonic vibration is amplified. Because ultrasonic vibration attenuates as it propagates through the water layer 34, the sound pressure differs between a location close to the ultrasonic horns 51, 54 and a location far from the ultrasonic horns 51, 54, even when the amplified ultrasonic vibration is the same. The uneven sound pressure may cause unevenness in the burr removal effectiveness.

Therefore, the burr removing apparatus 122 actively utilizes locations not far from the ultrasonic horns, among the locations where constructive interference occurs, to uniformly apply the amplified ultrasonic vibration across the entire workpiece 1. In particular, while the ultrasonic oscillator unit 150 is emitting ultrasonic vibrations, the controller 59 moves the ultrasonic oscillator unit 150 in the horizontal direction using the horizontal movement assembly, thereby scanning the entire upper surface of the workpiece 1. In other words, the ultrasonic oscillator unit 150 is moved relative to the workpiece 1 so that the ultrasonic oscillator unit 150 is sequentially located above each region of the upper surface of the workpiece 1. As a result, amplified ultrasonic vibration with sufficient sound pressure generated in the location close to the ultrasonic horns 51, 54 may be uniformly applied in turn to each region of the upper surface of the workpiece 1.

By the burr removing apparatus 122 according to the present embodiment, burrs may be also removed from the entire workpiece 1 reliably in a short period without specifying the locations of the burrs in advance. Other effects are also achievable by the burr removing apparatus 122 similarly the burr removing apparatus 22. Moreover, by the burr removing apparatus 122, ultrasonic vibration may be applied to act approximately uniformly on the workpiece 1 regardless of the position of the upper surface of the workpiece 1, and unevenness in burr removal effectiveness due to the positional differences may be prevented. Moreover, by applying the ultrasonic vibration uniformly to the upper surface of the workpiece 1, the sound pressure of the ultrasonic vibrations emitted from the ultrasonic horns may be reduced to the minimum intensity required for removing the burrs. Therefore, excessive pressure that may otherwise act on the workpiece 1 may be avoided.

In the present embodiment, burrs are removed from the entire workpiece 1 by applying amplified ultrasonic vibration across the entire surface without specifying the locations of the burr in advance. Meanwhile, optionally, the burr removing apparatus 122 may aim at grooves (kerfs) where the burrs are formed one by one and repeat the operation to remove the burrs on the groove basis as many times as the number of the aimed grooves.

In this case, first, for adjusting the position of the ultrasonic oscillator unit 150, the burr removing apparatus 122 adjusts the orientation of the workpiece 1 such that the predetermined dicing lines 13 of the workpiece 1 are aligned with the X-axis direction and the Y-axis directions, and the controller 59 controls the horizontal movement assembly 55 so that one of the predetermined dicing lines 13 extending in the X-axis direction is located at the intermediate position between the ultrasonic horn 51 and the ultrasonic horn 54 aligned in the Y-axis direction. In other words, the position of the ultrasonic oscillator unit 150 is adjusted so that the center line (perpendicular bisector) between the ultrasonic horn 51 and the ultrasonic horn 54, where the phase difference of the ultrasonic vibration is zero (0) and the ultrasonic vibration is amplified, overlaps the predetermined dicing line 13. Further in other words, the center line is located straight above the groove D (kerf).

After the position of the ultrasonic oscillator unit 150 is adjusted, the burr removing apparatus 122 operates the ultrasonic oscillator unit 150 to emit ultrasonic vibration. Accordingly, the ultrasonic vibration is amplified along the predetermined dicing lines 13 and acts on the burrs formed in the groove D along the predetermined dicing line 13.

Furthermore, the controller 59 controls the horizontal movement assembly 38 to move the ultrasonic oscillator unit 150 and the table 27 relative to each other. In other words, the ultrasonic oscillator unit 150 and table 27 are moved in the X-axis direction relative to each other. As described above, by locating the intermediate point between the ultrasonic horn 51 and the ultrasonic horn 54 on the predetermined dicing line 13, the ultrasonic vibration is amplified along the predetermined dicing line 13, but the amplitude of the amplified vibration varies depending on the position on the predetermined dicing line 13 along the X-axis. In other words, the vibration intensity (sound pressure) applied to the burrs varies depending on the position in the X-axis direction. Therefore, the burr removing apparatus 122 operates the horizontal movement assembly 38 to move the ultrasonic oscillator unit 150 and the table 27 relative to each other, thereby averaging the amplitude (i.e., the vibration intensity), which differs depending on the position in the X-axis direction, over time and applying vibration evenly to the entire burrs generated in the groove D regardless of the position in the X-axis direction.

Thereafter, the controller 59 aims at another predetermined dicing line 13 and repeats the above process for all of the predetermined dicing lines 13. As such, the burr removing apparatus 122 may entirely remove the burrs that are formed on the workpiece 1 when being cut.

According to the above method, the burr removing apparatus 122 may evenly apply amplified ultrasonic vibration entirely over the specific predetermined dicing line 13 by locating the predetermined dicing line 13 at the intermediate point between two ultrasonic horns and moving the ultrasonic oscillator unit 150 along the predetermined dicing line 13. Furthermore, no specifically complex positioning control is required, and each of the predetermined dicing lines 13 may be easily scanned with the amplified ultrasonic vibration, and the burrs may be reliably removed from the kerfs.

In the case where the predetermined dicing line 13 is located at the intermediate point between the two ultrasonic horns, the burr removing apparatus 122 also generates ultrasonic vibrations, of which phase difference changes over time, from the ultrasonic horn 51 and the ultrasonic horn 54. In other words, the power control unit 583 in the power source unit 58 is configured to be controlled by the controller 59 to continuously change the phase of the high-frequency power supplied by one of the high-frequency power source 581 and the high-frequency power source 582 relative to the phase of the high-frequency power supplied by the other of the high-frequency power source 581 and the high-frequency power source 582. By controlling the phase difference between the high frequency powers supplied from the high-frequency power source 581 and the high-frequency power source 582 to the pair of ultrasonic horns through the power control unit 583, the point at which the ultrasonic vibration is amplified is movable in the Y-axis direction between the ultrasonic horn 51 and the ultrasonic horn 54. The burr removing apparatus 122 may, under the control of the power control unit 583 as described above, shift the point where the ultrasonic vibration is amplified in the Y-axis direction on the workpiece 1, causing the point where the ultrasonic vibration is amplified to move across the groove D (kerf). Accordingly, even in a case where burrs are formed on an edge on either side in the kerf that has a certain width, the amplified ultrasonic vibration may be caused to act on the burrs, and the burrs may be removed reliably.

The burr removing apparatus 122 described above may be configured such that the regions, where the ultrasonic vibrations emitted from two ultrasonic horns are amplified, are moved across the upper surface of the workpiece 1 to remove the burrs. In this configuration, the power control unit 583 may control the power such that the phase difference changes continuously. For example, the power control unit 583 may control the power such that the phase difference changes stepwise at predetermined intervals, or such that the phase difference changes continuously at a predetermined rate.

For another example, the phase difference may be varied in one direction, for example, by 0°, 45°, 90°, 135°, 180°, 225°, 270°, 315°, 360°, and again 45°, and onward. For another example, the phase difference may be reversed at each full cycle, such as by 0°, 45°, . . . , 360°, then 315°, and onward. Moreover, the point where the ultrasonic vibration is amplified may not necessarily scan across the entire surface of the workpiece 1 but may move to at least traverse the kerf. Therefore, the phase difference may be changed within the corresponding range. For example, the phase difference may oscillate within a range smaller than 360°, such as by 0°, 45°, 90°, 135°, 90°, 45°, 0°, −45°, −90°, −135°, −90°, and onward, and the oscillation range may be adjusted in accordance with the width of the groove D.

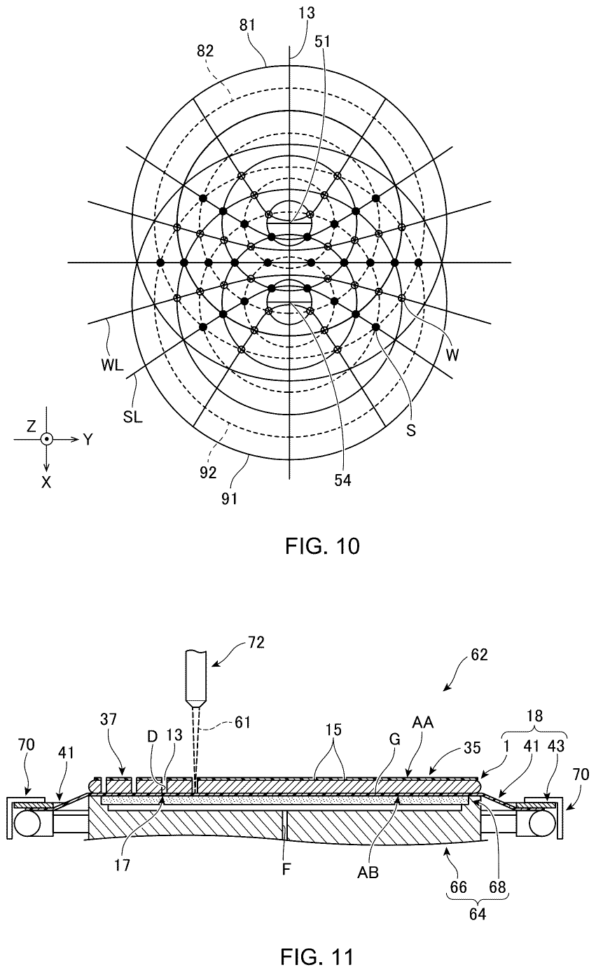

FIG. 10 illustrates wavefronts of in-phase ultrasonic waves output from the pair of ultrasonic horns arranged along the predetermined dicing line 13 and points where constructive and destructive interferences between the in-phase ultrasonic vibrations occur. In the above example, the ultrasonic horn 51 and the ultrasonic horn 54 were aligned in the Y-axis direction, which is orthogonal to the predetermined dicing line 13 to be processed for burr removal. However, as shown in FIG. 10, the ultrasonic horn 51 and the ultrasonic horn 54 may be aligned in the X-axis direction, along which the predetermined dicing line 13 to be processed for burr removal extends.

In the case where the ultrasonic horn 51 and the ultrasonic horn 54 are aligned along the kerf, by locating the predetermined dicing line 13 on the intermediate point between the ultrasonic horn 51 and the ultrasonic horn 54 and moving the ultrasonic oscillator unit 150 along the predetermined dicing line 13, the amplified ultrasonic vibration may be uniformly applied across the entire predetermined dicing line 13. In such a case, the line SL connecting the points where the ultrasonic vibration is amplified is arranged so as to traverse the kerf, thereby enabling the amplified ultrasonic vibration to act on the burrs formed at an edge on either side of the kerf.

Also in the case where the ultrasonic horn 51 and the ultrasonic horn 54 are aligned in the X-axis direction, the ultrasonic horn 51 and the ultrasonic horn 54 may emit ultrasonic vibrations such that the phase difference of those changes over time.

While an embodiment of the present invention has been described, embodiments of the present disclosure may not necessarily be limited to the configuration described above or in the modified example but may be modified, substituted, or altered in various ways without departing from the spirit of the technical idea of the present disclosure. Furthermore, if the technical idea of the present disclosure may be realized in a different way due to technological progress or other derived technology, it may be implemented with use of the method. Therefore, the claims cover all embodiments that may be included within the scope of the technical idea of the present disclosure.

In the embodiments described above, the ultrasonic oscillator unit 50, 150 includes a single pair of ultrasonic horns; however, the ultrasonic oscillator unit 50, 150 may include multiple pairs of ultrasonic horns. When multiple pairs of ultrasonic horns are provided, the ultrasonic horns of each pair are preferably arranged in such a manner that the ultrasonic vibration from one pair should not attenuate the ultrasonic vibration from another pair excessively at the point where the ultrasonic vibration should be amplified. Thus, the pairs of ultrasonic horns should be placed at a certain distance from one another.

In the embodiments described above, two examples, in which the distance between the pair of ultrasonic horns in the ultrasonic oscillator unit 50, 150 is 100 mm and 45 mm, respectively; however, the distance between the pair of ultrasonic horns is not limited to these values. The distance between the pair of ultrasonic horns may be any value as long as the ultrasonic horns do not contact each other and the range is within approximately the diameter of the wafer. For example, the distance between the pair of ultrasonic horns may be suitably adjusted within a range of 41 mm to 200 mm.

The embodiments described above showed an example, in which the distance from the lower surface of the plate 501 to the upper surface of the wafer is 5 mm. However, the distance is not limited to 5 mm but may be set within a range of, for example, 1 mm to 10 mm.

The embodiment described above showed an example, in which burrs caused by a cutting blade are removed, but the burrs to be removed by the burr removing apparatus described above are not limited to those caused by a specific processing method. For example, the burr removing apparatus may remove burrs caused not only by a cutting blade (cutting device 2) but also by a laser processing apparatus 62 shown in FIG. 11. For example, after a protective film 35 is formed on the front surface AA of the workpiece 1, in order to divide the workpiece 1 into smaller regions 1 each having the device 15 formed thereon, regions in the workpiece 1 corresponding to the predetermined dicing lines 13 may be removed by laser ablation from the side of the protective film 35, and burrs that are formed in the process of laser ablation may be removed by the burr removing apparatus.

Moreover, as the ultrasonic vibration amplified by the phase difference moves across the upper surface of the wafer, the surface of the wafer may be cleaned effectively in the process. As such, burrs that are removed may be prevented from remaining on the upper surface of the wafer.

FIG. 11 is a cross-sectional view of the laser processing apparatus 62 according to an embodiment. Below, with reference to FIG. 11, another example of method for processing the workpiece 1, in which the regions in the workpiece 1 corresponding to the predetermined dicing lines 13 are removed from the side of the protective film 35 formed on the front surface AA to form chips 37, will be described.

The protective film 35 may be formed using, for example, a spin coater. A frame set 18 is set in the spin coater with the front surface AA of the workpiece 1 facing upward. A liquid resin is applied to the front surface AA, and the frame set 18 is rotated so that the liquid resin is spread by centrifugal force to form the protective film 35.

The frame set 18 is composed integrally of a ring-shaped frame 43 and the workpiece 1 adhered to a tape 41 that closes an opening of the frame 43. In the frame set 18, unlike the frame set 11, the tape 41 that closes the opening of the frame 43 is adhered to the back surface AB of the workpiece 1.

A material of the protective film 35 is not particularly limited, but may be a material that may form a water-soluble protective film resistant to plasma etching. For example, water-soluble polyvinyl alcohol (PVA) or polyvinylpyrrolidone (PVP) may be used.

The laser processing apparatus 62 shown in FIG. 11 includes a chuck table 64 to hold the workpiece 1 which is included in the frame set 18, a plurality of clamps 70 to hold the frame 43 which is included in the frame set 18, and a laser irradiation unit 72 to irradiate the workpiece 1 with a laser beam.

The chuck table 64 includes a frame 66 having a recess formed on an upper surface thereof, and a holder plate 68 embedded in the recess of the frame 66. In the frame 66, a flow path F that connects the recess in the frame 66 and a suction source (not shown) is formed. The holder plate 68 is a porous plate.

The frame 66 (the chuck table 64) is supported by a movement assembly, which is not shown, and is movable in two directions (a process-feeding direction and an index-feeding direction) intersecting orthogonally to each other and substantially parallel to a holder surface G

The laser irradiation unit 72 is provided above the chuck table 64. The laser irradiation unit 72 irradiates the workpiece 1 with a laser beam 61, which has a wavelength absorbable by the workpiece 1 and is emitted from a short-pulse laser, from the side of the protective film 35.

For removing the regions of the workpiece 1 corresponding to the predetermined dicing lines 13 to form chips 37 from the workpiece 1, first, the laser irradiation unit 72 configured as described above holds the frame set 18 with the protective film 35 facing the laser irradiation unit 72. In particular, the plurality of clamps 70 hold the frame 43. Further, a suction source (not shown) generates a negative pressure at the holder surface G, and with the suctioning force, the chuck table 64 holds the workpiece 1 via the tape 21 with the negative pressure.

Next, the laser processing apparatus 62 locates the laser irradiation unit 72 in one of the regions corresponding to the predetermined dicing lines 13. For example, a rotation assembly supporting the chuck table 64 may rotate the chuck table 64 so that the predetermined dicing line 13 aligns parallel to the process-feeding direction. Next, the movement assembly, which may move the chuck table 64 in the process-feeding direction and the index-feeding direction, moves the chuck table 64 in the index-feeding direction so that the laser irradiation unit 72 is located above the region corresponding to the predetermined dicing line 13.

Once the laser irradiation unit 72 is located above the region corresponding to the predetermined dicing line 13, the laser processing apparatus 62 operates the laser irradiation unit 72 to emit the laser beam 61 at the workpiece 1 and operates the movement assembly to move the chuck table 64 in the process-feeding direction. As such, a groove D is formed by laser ablation in the region corresponding to the predetermined dicing line 13. The above operation is repeated for all of the regions corresponding to the predetermined dicing lines 13 to form the grooves D along the predetermined dicing lines 13, and burrs may be formed at the upper ends of the grooves D as regions melt and cool during the laser ablation.

The above-described burr removing apparatus may remove burrs caused by laser processing in the same procedure as removal of the burrs caused by the cutting blade 16. The laser processing apparatus 62 and the laser irradiation unit 72 are an example of a dicing device that may divide the workpiece 1 using the laser beam 61 (laser light) to form the chips 37. The burr removing apparatus is an example of the burr removing apparatus that may remove burrs from the workpiece 1 in which the kerfs (grooves) are formed by the dicing device using the laser beam. If burrs are formed on the front surface AA side of the workpiece 1 by the laser processing shown in FIG. 11, the workpiece 1 is set in the burr removing apparatus to remove the burrs with the front surface AA facing upward and the back surface AB downward.

The method for removing burrs according to the present disclosure is not necessarily limited to that described above as long as it includes the step for forming the water layer 34 between the upper surface of the workpiece 1 and the lower surface of the ultrasonic oscillator unit 50. For example, the water layer 34 may be formed by locating the lower surface of the ultrasonic oscillator unit 50 on the water layer already formed on the workpiece 1, or the water layer 34 may be formed between the upper surface of the workpiece 1 and the lower surface of the ultrasonic oscillator unit 50 by first spacing apart the workpiece 1 and the ultrasonic oscillator unit 50 to form a gap and then supplying water into the gap.

As described above, the burr removing apparatus according to the present disclosure may remove burrs formed on the workpiece 1 by applying amplified ultrasonic vibration generated from a pair of ultrasonic horns, thereby preventing potential defects that may otherwise be caused in the processed product due to the burrs. As such, the burr removing apparatus is highly effective in removing burrs caused by cutting or laser processing.

### CROSS REFERENCE TO RELATED APPLICATION

This application is based upon and claims the benefit of priority from the prior Japanese Patent Applications No. 2023-188081 filed on Nov. 2, 2023 and No. 2024-129017 filed on Aug. 5, 2024; the entire contents of which are incorporated herein by reference.

1. A burr removing apparatus configured to remove a burr formed in a kerf, the kerf being formed in a workpiece with a cutting blade or a laser beam, comprising:
a table configured to hold a lower surface of the workpiece;
an ultrasonic oscillator unit arranged so as to be spaced apart from an upper surface of the workpiece held by the table, the ultrasonic oscillator unit being configured to emit ultrasonic vibration toward the upper surface of the workpiece; and
a water layer forming device configured to form a water layer between the upper surface of the workpiece held by the table and the lower surface of the ultrasonic oscillator unit,
wherein the ultrasonic oscillator unit includes a plate and two columnar ultrasonic horns spaced apart from each other,
wherein the burr removing apparatus further comprises:
a horizontal movement assembly configured to move the ultrasonic oscillator unit and the table relative to each other in parallel with the upper surface of the table;
a controller configured to operate the horizontal movement assembly to move the ultrasonic oscillator unit and the table relative to each other;
a high-frequency power source configured to supply high-frequency power to the two ultrasonic horns; and
a power control unit configured to change a phase of the high-frequency power to be supplied to one of the ultrasonic horns with respect to a phase of the other of the ultrasonic horns continuously,
wherein the burr removing apparatus is configured to remove the burr from the workpiece by changing the phase of the high-frequency power to be supplied to the one of the two ultrasonic horns continuously and causing a location, where the ultrasonic vibrations emitted from the two ultrasonic horns are amplified, to be moved on the upper surface of the workpiece.

2. The burr removing apparatus according to claim 1, wherein the controller operates the horizontal movement assembly to move the ultrasonic oscillator unit in a horizontal direction continuously and remove the burr entirely across the upper surface of the workpiece.

3. The burr removing apparatus according to claim 1,
wherein the two ultrasonic horns are aligned in an X-axis direction, the X-axis direction being an extending direction of the kerf,
wherein the horizontal movement assembly includes:
an X-axis movement assembly configured to move the ultrasonic oscillator unit and the table relative to each other in the X-axis direction; and
a Y-axis movement assembly configured to move the ultrasonic oscillator unit and the table relative to each other in a Y-axis direction, the Y-axis direction intersecting orthogonally with the X-axis direction,
wherein the controller is configured to, for each kerf formed in the workpiece, operate the Y-axis movement assembly to locate an intermediate point between the two ultrasonic horns at a position straight above the kerf and thereafter operate the X-axis movement assembly to move the ultrasonic oscillator unit in the X-axis direction along the kerf, to remove the burr formed on the kerf.

4. A method for removing burrs formed in a kerf, the kerf being formed in a workpiece with a cutting blade or a laser beam, by applying ultrasonic vibration emitted from an ultrasonic oscillator unit to the burr, the ultrasonic oscillator unit including a plate and two columnar ultrasonic horns, to which high-frequency power is supplied from a high-frequency power source, the two ultrasonic horns being spaced apart from each other, the method comprising:
holding the workpiece by a table;
forming a water layer between a lower surface of the ultrasonic oscillator unit located apart from an upper surface of the workpiece held by the table and the upper surface of the workpiece; and
removing the burrs from the kerf entirely across the upper surface of the workpiece by:
changing a phase of the high-frequency power to be supplied from the high-frequency power source to one of the two ultrasonic horns with respect to a phase of the high-frequency power to be supplied from the high-frequency power source to the other of the two ultrasonic horns continuously to move a location, where the ultrasonic vibrations emitted from the two ultrasonic horns are amplified, on the upper surface of the workpiece, and
moving the ultrasonic oscillator unit and the table relative to each other in a horizontal direction.
